(19) United States
(12) Patent Application Publication
(10) Pub. No.: US 2011/0298296 A1
(43) Pub. Date: Dec. 8, 2011

(54) RECTIFIER CIRCUIT OF WIRELESS POWER TRANSMISSION SYSTEM

(75) Inventor: Sang Hoon Hwang, Seoul (KR)

(73) Assignee: SAMSUNG ELECTRO-MECHANICS CO., LTD., Gyunggi do (KR)

(21) Appl. No.: 13/153,334

(22) Filed: Jun. 3, 2011

(30) Foreign Application Priority Data
Jun. 7, 2010 (KR) 1020100053499

(51) Int. Cl. H01F 38/14

(52) U.S. Cl. 307/104

(57) ABSTRACT

Disclosed herein is a rectifier circuit of a wireless power transmission system, the rectifier circuit including: a rectifying unit rectifying an RF signal inputted through an RF input stage in a half-wave rectification type; an impedance matching unit installed between the RF input stage and the rectifying unit to match an impedance between the RF input stage and the rectifying unit; and a filtering unit filtering the signal rectified by the rectifying unit, thereby removing a radio frequency component and reducing a radio frequency ringing phenomenon, and thus, improving the efficiency of the rectifier circuit.

### CROSS REFERENCE TO RELATED APPLICATION

This application claims the benefit of Korean Patent Application No. 10-2010-0053499, filed on Jun. 7, 2010, entitled “Rectifier Circuit of Wireless Power Transmission System”, which is hereby incorporated by reference in its entirety into this application.

### BACKGROUND OF THE INVENTION

1. Technical Field

The present invention relates to a rectifier circuit of a wireless power transmission system.

2. Description of the Prior Art

A communication system, with the development of IT technologies, has continued to develop rapidly based on a boundlessly expansive field with respect to wireless in the 2000s.

As the result, the communication system has newly changed into a user-oriented system free from restraint by time and place and conveniently portable.

However, power and energy transmission still depends on a wire system despite the development of this communication system, and thus is much restricted by time and place in actually using the system. Therefore, full wireless of the system has been difficult to realize actually.

At present, a radio wave receiving type technology using radio waves, a magnetic induction type technology using a magnetic field, and a magnetic resonance technology by energy conversion of a magnetic field and an electric field, and the like, are representatively employed in a wireless power transmission technology.

The radio wave receiving type technology radiates radio waves to the air through an antenna, so that power can be transmitted over a long distance, but is very large in radiation loss to the air and thus have a limitation in efficiency of power transmission.

Meanwhile, the magnetic induction type technology uses the combining of magnetic energy by a primary coil of a transmitting side and a secondary coil of a receiving side, and has high efficiency in power transmission.

However, in the magnetic induction type technology, the primary coil of the transmitting side and the secondary coil of the receiving side need to be close at a short distance by about several millimeters for power transmission.

In addition, there are problems in that the efficiency of power transmission is rapidly changed according to the coil alignment of the primary coil of the transmitting side and the secondary coil of the receiving side and the calorific value is large.

Therefore, in recent years, the magnetic resonance technology, which is similar to the magnetic induction type technology but transmits the power in a form of magnetic energy by concentrating energy on a specific resonance frequency by a coil type inductor L and a capacitor C, is being developed.

This magnetic resonance technology can transmit the relatively larger power up to several meters, but requires a high quality factor.

On the other hand, a size and an efficiency of the system are very important in the above magnetic resonance type wireless power transmission system.

In other words, the wireless power transmission system needs to have a smaller size and a higher efficiency, but to achieve this, radio frequency is relatively favorable than low frequency.

However, the power system uses radio frequency to increase power density, but has a limitation in that, in order to achieve high efficiency at a rectifier terminal, parasitic components need to be minimized to reduce a parasitic RF ringing phenomenon. Therefore, there are many problems in embodying the use of radio frequency.

A parasitic inductance is surely much less due to the development of a packaging technology, but still existing parasitic inductance components form a radio frequency harmonic to generate noise, thereby decreasing the entire efficiency of a converter.

### SUMMARY OF THE INVENTION

The present invention has been made in an effort to provide a rectifier circuit of a wireless power transmission system capable of improving efficiency of the rectifier circuit by removing a radio frequency noise component and reducing an RF ringing phenomenon.

According to a preferred embodiment of the present invention, there is provided a rectifier circuit of a wireless power transmission system, the rectifier circuit including: a rectifying unit rectifying an RF signal inputted through an RF input stage in a half-wave rectification type; an impedance matching unit installed between the RF input stage and the rectifying unit to match an impedance between the RF input stage and the rectifying unit; and a filtering unit filtering the signal rectified by the rectifying unit.

The rectifying unit may include: a first diode connected in series between the impedance matching unit and the filtering unit; a capacitor connected in parallel with the first diode between the impedance matching unit and the filtering unit; and a second diode connected in parallel with the first diode between a cathode terminal of the first diode and a ground.

The impedance matching unit may include a capacitor connected in series between the RF input stage and the rectifying unit.

The filtering unit may include: an inductor connected in series between the rectifying unit and an output stage; a first capacitor connected in parallel with the inductor between one end of the inductor and a ground; and a second capacitor connected in parallel with the first capacitor between the other end of the inductor and the ground.

### BRIEF DESCRIPTION OF THE DRAWINGS

FIG. 1 is a circuit diagram showing a rectifier circuit of a wireless power transmission system according to a preferred embodiment of the present invention;

FIG. 2 is a view showing an operation of the rectifier circuit shown in FIG. 1;

FIG. 3 is a graph showing a radio frequency harmonic generated in a bridge rectifier circuit of the prior art;

FIG. 4 is a graph showing removal of radio frequency noise by the rectifier circuit shown in FIG. 1; and

FIG. 5 is a graph showing an efficiency of the rectifier circuit shown in FIG. 1 and an efficiency of the bridge rectifier circuit of the prior art.

### DESCRIPTION OF THE PREFERRED EMBODIMENTS

The above and other objects, features and advantages of the present invention will be more clearly understood from the following detailed description taken in conjunction with the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

In the specification, in adding reference numerals to components throughout the drawings, it is to be noted that like reference numerals designate like components even though components are shown in different drawings.

Further, when it is determined that the detailed description of the known art related to the present invention may obscure the gist of the present invention, the detailed description thereof will be omitted.

Hereinafter, preferred embodiments of the present invention will be described in detail with reference to the accompanying drawings.

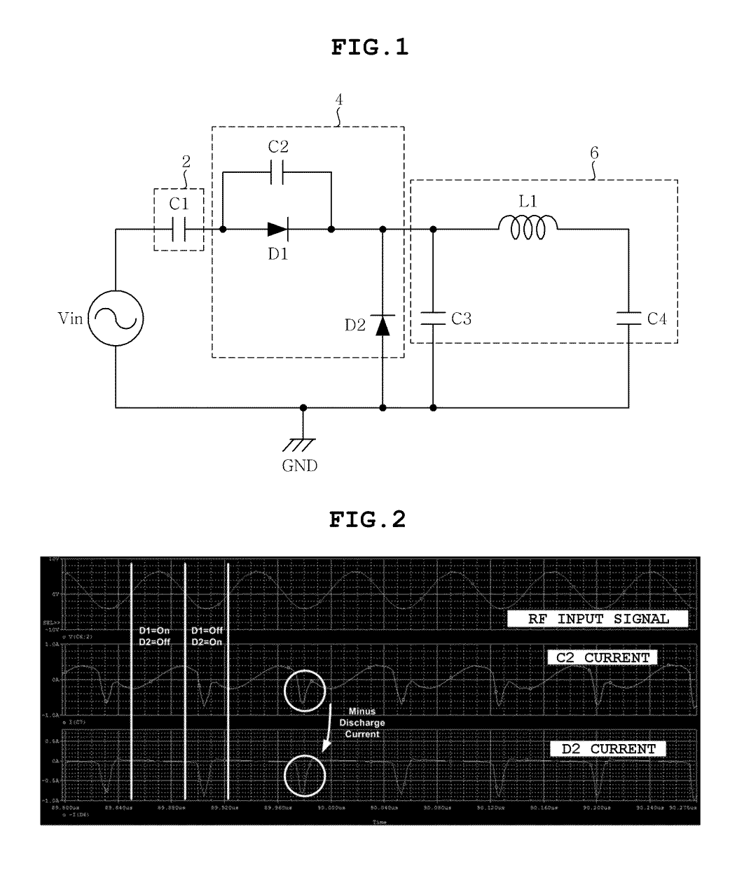

FIG. 1 is a circuit diagram showing a rectifier circuit of a wireless power transmission system according to a preferred embodiment of the present invention.

A rectifier circuit of a wireless power transmission system according to a preferred embodiment of the present invention, as shown in FIG. 1, includes an impedance matching unit 2, a rectifying unit 4, and a filtering unit 6.

The impedance matching unit 2 is installed between an RF input stage Vin and the rectifying unit 4, in order to match an impedance between the RF input stage Vin and the rectifying unit 4.

This impedance matching unit 2 consists of a first capacitor C1 connected in series between the RF input stage Vin and the rectifying unit 4.

The rectifying unit 4 rectifies an RF signal inputted through the RF input stage in a half-wave rectification type.

To achieve this, the rectifying unit 4 consists of a first diode D1 connected in series between the impedance matching unit 2 and the filtering unit 6, a second capacitor C2 connected in parallel with the first diode D1 between the impedance matching unit 2 and the filtering unit 6, and a second diode D2 connected in series between an output terminal of the first diode D1 and the ground (GND) to be connected in parallel with the first diode D1.

The filtering unit 6 filters the signal rectified by the rectifying unit 4, and preferably employs a high-order filter in order to improve the filtering characteristic.

This filtering unit 6 is constituted to include a third capacitor C3 connected in parallel with the second diode D2 between a common terminal of a cathode terminal of the first diode D1 and a cathode terminal of the second diode D2 and the ground GND, a fourth capacitor C4 connected in parallel with the third capacitor C3, and an inductor L1 connected in parallel with the third capacitor C3 and the fourth capacitor C4 between the third capacitor C3 and the fourth capacitor C4, and thus serves as a low pass filter.

Here, a common terminal of the inductor L1 and the fourth capacitor C4 is used as an output stage outputting a DC voltage.

As for the rectifier circuit of the wireless power transmission system according to the preferred embodiment of the present invention having this configuration, since a capacitance value of the first capacitor C1 is much larger than a capacitance value of a parasitic capacitor of the first diode D1 (that is, an inside capacitor of the first diode D1), an input impedance is fixed to almost the capacitance value of the first capacitor C1.

On the other hand, in the rectifier circuit of the wireless power transmission system according to the preferred embodiment of the present invention having the above configuration, an input covers a radio frequency source of 10 MHz or more (preferably 13.56 MHz) on which parasitic resonance has an important influence, and an output has a stable DC voltage characteristic of ripple of 100 mV or less.

To achieve this, the rectifier circuit of the wireless power transmission system according to the preferred embodiment of the present invention having the above configuration preferably satisfies the following conditions.

i) An input source (that is, RF input) is a sine waveform of the minimum harmonic, and has a duty cycle of 50%.

ii) Diodes of the rectifying unit 4 (that is, the first diode D1 and the second diode D2) have no conduction loss, and have off resistance.

iii) A switching operation occurs without delay in an instant.

The operation of the rectifier circuit of the wireless power transmission system according to the preferred embodiment of the present invention having the above configuration with such conditions will be described with reference to FIG. 2 as follows.

First, when a forward (+) RF signal is inputted through the RF input stage Vin, the first diode D1 is conducted.

Here, since the total current flows through the second capacitor C2 and the first diode D1, the current flowing through the second diode D2 becomes zero.

That is, when the forward RF signal is inputted through the RF input stage Vin, the second diode D2 is not conducted.

Meanwhile, the current dominantly flows through the second capacitor C2 having a relatively large admittance.

Here, a junction capacitor of the second diode D2 (that is, an inside capacitor) is charged to increase a voltage across both terminals of the second diode D2.

The RF input signal has the maximum value, and the junction capacitor of the second diode D2 is discharged to a load (that is, an output stage) to decrease the voltage across both terminals of the second diode D2 and make the voltage across both terminals of the second diode D2 zero, and thus, the second diode D2 becomes conducted in a forward direction.

As such, when the second diode D2 is forwardly conducted, that is to say, a reward (−) RF signal is inputted through the RF input stage Vin, the second diode D2 is conducted, whereas the first diode D1 is electrically cut off since the reward (−) RF signal is a reverse bias to the first diode D1.

As such, during the half period, the voltage across both terminals of the second diode D2 becomes zero, and thus power is not transmitted to the load.

In addition, the current flowing through the capacitor of the first diode D1 becomes zero.

However, since a current path is still connected through the second capacitor C2 connected in parallel with the first diode D1, conduction of the second diode D2 leads to the attraction of negative charges (But for the current path by the second capacitor C2, the second diode D2 attracts current to the load).

The current of the second diode D2 has the maximum value, and a slope of the current flowing through the second capacitor C2 is changed to a positive sign, and thus, the first diode D1 is conducted in a forward direction.

As such, the rectifier circuit of the wireless power transmission system according to the preferred embodiment of the present invention is capable of removing the radio frequency noise component by the second capacitor C2 connected in parallel with the first diode D1.

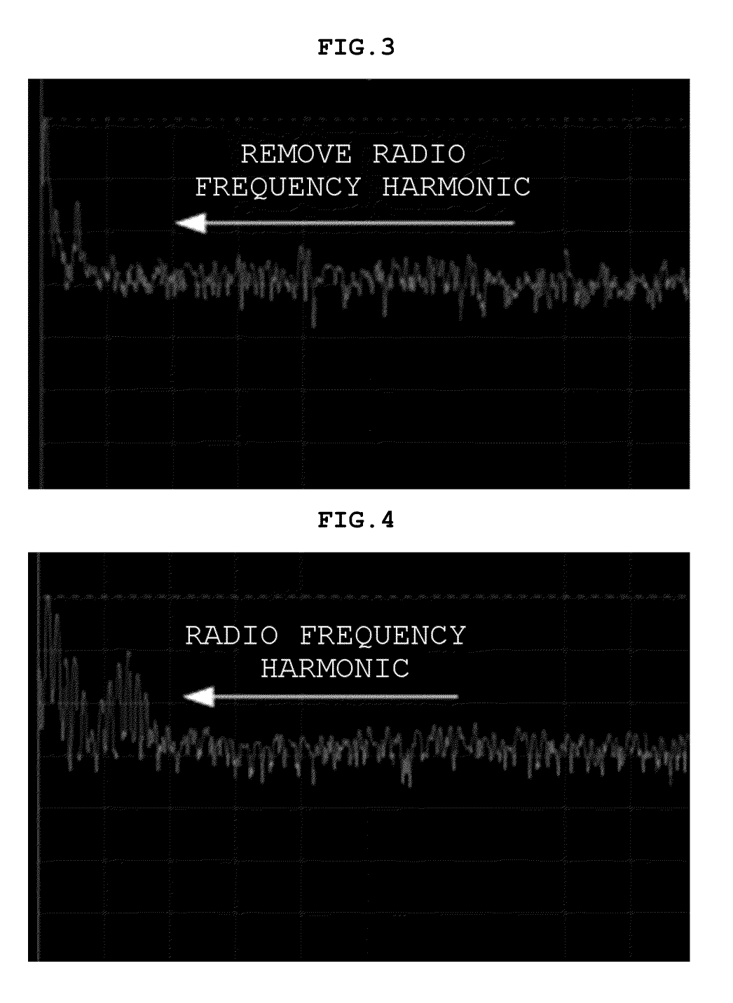

In other words, in a case of the bridge rectifier circuit used in the prior art, there exists the radio frequency noise component, as shown in FIG. 3, whereas in a case of the rectifier circuit of the wireless power transmission system according to the preferred embodiment of the present invention, the noise component is removed by the second capacitor C2 connected in parallel with the first diode D1, when viewed from an output node of the first diode D1, as shown in FIG. 4.

For this reason, the rectifier circuit of the wireless power transmission system according to the preferred embodiment of the present invention is capable of reducing the RF ringing phenomenon, and thereby has an effect of improving the efficiency thereof.

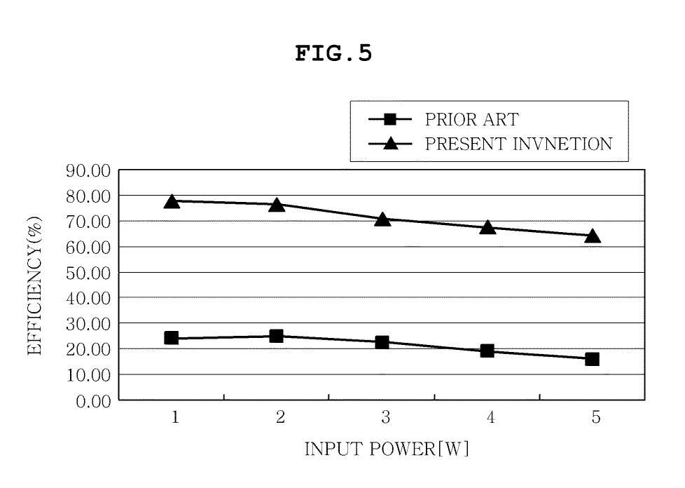

Moreover, the rectifier circuit of the wireless power transmission system according to the preferred embodiment of the present invention having such configuration has a more improved efficiency thereof by approximately 50% or more than the rectifier circuit using the bridge rectifier of the prior art, as shown in FIG. 5.

As set forth above, according to the present invention, a radio frequency noise component can be removed and the radio frequency ringing phenomenon can be reduced by using the capacitor connected in parallel with the diode passing the forward signal, thereby improving the efficiency of the rectifier circuit.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A rectifier circuit of a wireless power transmission system, the rectifier circuit comprising:
a rectifying unit rectifying an RF signal inputted through an RF input stage in a half-wave rectification type;
an impedance matching unit installed between the RF input stage and the rectifying unit to match an impedance between the RF input stage and the rectifying unit; and
a filtering unit filtering the signal rectified by the rectifying unit.

2. The rectifier circuit as set forth in claim 1, wherein the rectifying unit includes:
a first diode connected in series between the impedance matching unit and the filtering unit;
a capacitor connected in parallel with the first diode between the impedance matching unit and the filtering unit; and
a second diode connected in parallel with the first diode between a cathode terminal of the first diode and a ground.

3. The rectifier circuit as set forth in claim 1, wherein the impedance matching unit includes a capacitor connected in series between the RF input stage and the rectifying unit.

4. The rectifier circuit as set forth in claim 1, wherein the filtering unit includes:
an inductor connected in series between the rectifying unit and an output stage;
a first capacitor connected in parallel with the inductor between one end of the inductor and a ground; and
a second capacitor connected in parallel with the first capacitor between the other end of the inductor and the ground.
